(19) United States
(12) Patent Application Publication
(10) Pub. No.: US 2006/0045693 A1
(43) Pub. Date: Mar. 2, 2006

(54) Vehicle trailer with adjustable bed height

(76) Inventors: Eric Elliot, Renfrew (CA); Bruce Presley, Renfrew (CA); Regan Ellis, Renfrew (CA)

Correspondence Address: MILTON, GELLER, LLP, 700 - 225 METCALFE STREET, OTTAWA, ON, K2P-1P9, CA

(21) Appl. No.: 10/923,001

(22) Filed: Aug. 23, 2004

(51) Int. Cl. B60P 1/04

(52) U.S. Cl. 414/481

(57) ABSTRACT

A vehicle trailer is provided with a cargo bed which may be placed in an elevated condition for traveling, or lowered to a surface beneath the trailer for loading. A preferred means of controlling the position of the cargo bed is through cables connected both to a hinged portion of a tongue shaft at the forward end of the trailer, and to hinged wheel support arms mounted towards the rearward portion of the trailer. By taking-up cable, the cargo platform is elevated. Letting out cable lowers the cargo platform. During these transitions, both the tongue shaft and wheel support arms rotate either towards or away from alignment with the frame.

### FIELD OF INVENTION

This invention relates to trailers of the type typically towed behind passenger cars and pickup trucks. More particularly, it relates to trailers having a platform which may be reoriented in order to facilitate the loading of cargo onto the bed of the trailer.

### BACKGROUND OF THE INVENTION

A typical small-vehicle trailer has two to four outboard wheels, a frame carrying the wheels, a cargo platform, and a tongue for connecting the frame to a towing vehicle through a hitch. For a trailer with two wheels, the cargo platform can be tilted to assist in loading cargo, such as a Snowmobile, onto the trailer.

Proposals have been made to allow such a trailer to be tilted with either its rearward edge or its forward edge touching the ground. This effect has been achieved, for example, by providing means by which a hinged tongue shaft may be angled upwards from the forward edge of the platform to cause such edge to touch the ground; or depressed at a downward angle to allow the rear edge of the platform to touch the ground. Such tilting actions can be achieved in some cases with the trailer still attached through its tongue to the hitch on a towing vehicle. Examples of prior patents in this category include U.S. Pat. No. 6,537,014 to Ridgill; U.S. Pat. No. 6,589,005 to Hull; U.S. Pat. No. 5,924,836 to Kelly; U.S. Pat. No. 5,540,538 to Head Sr; U.S. Pat. No. 5,468,054 to Soules; U.S. Pat. No. 5,016,896 to Schafer and U.S. Pat. No. 3,807,593 to Bourton.

Other designs have been directed to systems for actually lowering the cargo bed from an elevated, traveling, position to a ground-level, loading, position. Examples in this category include U.S. Pat. No. 4,008,902 to Dill; U.S. Pat. No. 5,478,416 to Rogge, and U.S. Pat. No. 5,975,828 to Weldy.

One particular reference, U.S. Pat. No. 4,490,089 to Welker, shows the cargo platform as simply an upwardly open 8 inch wide steel channel, designed to carry a motorcycle. Welker employs a cable connected to this platform at the end closest to the vehicle. A cable winch in this Welker reference is coupled to a member that constitutes a frame passing above the axle of the two wheels. Welker further shows the presence of a hinged portion on the trailer tongue. However, in Welker the cable serves only to draw two components together, in the course of elevating the cargo platform.

Another particular reference is U.S. Pat. No. 5,308,213 to Gilbertson. Gilbertson as well includes a hinged portion on the tongue shaft and relies on a cable to draw two components together in the course of elevating the cargo platform. While both of these references rely on cable to elevate a support platform on a trailer from a loading position on the road surface to an elevated traveling position, both of these references show cable connected to the bed of the trailer only at the end closest to the vehicle.

An opportunity exists to provide an improved design for a vehicle trailer that allows the cargo bed or platform to be readily lowered to the traveling surface for loading, and elevated for use in transit. The invention herein addresses such an objective.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

According to the present invention in one aspect, a vehicle trailer is provided with a platform or bed for supporting cargo that may be lowered to the road surface beneath the trailer for loading, and then may be elevated for transport. This is achieved by providing:
a) a frame for supporting the cargo bed;
b) a tongue shaft attached at its rearward end to the frame through a hinged joint, the forward end of the tongue shaft being provided with hitch means for coupling to a vehicle;
c) a pair of wheel support arms that are connected at one end of each of the respective arms to the frame through respective hinged joints to permit the wheel support arms to rotate in conjunction with the rotation of the tongue shaft;
   d) at least two wheels fitted through wheel axles to the wheel support arms, and
   e) means to cause rotation of both the tongue shaft and wheel support arms to permit the frame and cargo bed to be lowered or raised with respect to the wheel axles.

According to one variant of the invention, the frame is lowered to a loading configuration by rotating both the tongue shaft and the wheel support arms upwardly, away from alignment with the frame. Conversely, the frame is raised upwardly into a traveling configuration by rotating the tongue shaft and the wheel support arms downwardly, towards alignment with the frame. In a preferred variant, the wheel support arms and tongue shaft are fully aligned with the frame in the traveling configuration.

With the elevation and lowering of the frame, the wheel support arms may rotate in the same direction as the tongue shaft rotates. Alternately, with the elevation and lowering of the frame, the wheel support arms may rotate in the opposite direction to the rotation of the tongue shaft.

According to one variant, when in traveling mode, locking pins are inserted respectively through the tongue shaft and wheel support arms to engage with member portions of the frame to engage these components together. According to another variant, one or both of the tongue shaft and wheel support arms carry the weight of the cargo bed through cabling which is also used to raise and lower the frame.

In order to elevate and lower the frame, various means may be used to rotate the tongue shaft and wheel support arms. These include screws, air cylinders and hydraulic cylinders. According to a preferred variant, a cable linkage system is used which employs cable connected at one end of the cable to the tongue shaft and at the other end of the cable to the wheel support arms in order to effect a rotation of the wheel support arms. Between these two anchor points, the cable is routed through pulleys connected to the frame. A cable take-up means is used to effect transmission between the two modes. Such cable take-up means is preferably in the form of a winch carried by the trailer. The winch may optionally be mounted in association with the tongue shaft or it may be mounted in association with the frame, as well as at any other location where it can serve to take-up the cable. The winch may be manually operated or powered.

Upon the taking-up and shortening of the cable, the tongue shaft and wheel support arms are respectively drawn towards alignment with the frame into a traveling configuration, concurrently with effecting elevation of the frame and cargo bed. Upon the letting-out and lengthening of the cable, the tongue shaft and wheel support arms are respectively permitted to swing away from alignment with the frame under the effect of gravity exerted on the trailer frame and bed. Eventually, this will place the cargo bed of the trailer virtually on the surface beneath the trailer, in a loading configuration.

Optionally, preferably, one or more leveraging pulleys are provided and the cable is routed through such leveraging pulleys to achieve a leveraging effect.

While the cabling may be routed to apply simultaneous force to both of the wheel support arms, such arms may be caused to move in unison, and in parallel, by linking them through a common hinge shaft journalled in the frame or in an extension of the frame. This common wheel support arm hinge shaft extends transversely across the frame, from one side of the trailer where it is connected to one wheel support arm, to the other side of the trailer, where it is connected with the other wheel support arm. In this configuration, even when imbalanced forces are delivered to the respective wheel support arms through the cable, such arms nevertheless will rotate in unison due to the transfer of torque through the common hinge shaft.

While locking pins may fix the tongue shaft and wheel support arms in place when in traveling condition, as an alternate arrangement, one or both of such pins may be omitted. This then places the load of the cargo bed and its cargo on the cable while traveling. By selection of cable which is both sufficiently strong and resilient, a suspension or cushioning effect can then be achieved for the cargo platform. This suspension effect can be further improved by inclusion of spring means in the tension-bearing links extending between the tongue shaft and the wheel support arms through the cabling.

The invention also provides for a method of loading cargo onto the cargo bed of such a vehicle trailer by causing rotation and closure of either the tongue shaft or wheel support arms to occur selectively or preferentially, permitting either the forward end or rearward end of the platform to contact the road surface with the other end of remaining elevated. This may be achieved by the simple expedient of supporting either one end of the trailer bed or the other while letting-out the cable. A load may then be either advanced onto or off of the cargo platform over the end of the platform which has been lowered into contact with the road surface.

The system of the invention is, however, particularly advantageous when a load is to be placed upon a trailer and it is awkward to advance the load up a severely inclined cargo bed. This may occur where the load is heavy or must be maintained in a horizontal orientation.

The system of the invention is also advantageous when used as a boat trailer intended to launch and recover boats from an inclined trailer launching ramp. Because the cargo bed of the trailer may be lowered, the extent to which a towing vehicle must back down an inclined trailer launch ramp is reduced. Thus, if previously with an elevated cargo bed, the rear end of such a vehicle must be backed fully into the water then, with a trailer according to the invention, such towing vehicle would not have to be backed as far down the ramp or as deeply into the water, if it need be backed into the water at all.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is an oblique, side view of a trailer according to the invention with the cargo bed in a lowered, loading position.

FIG. 2 is an oblique, side view of a trailer as in FIG. 1 with the cargo bed in a more elevated position, proceeding towards a traveling mode.

FIG. 3 is a plan view of the trailer as in FIG. 1 showing the routing of lifting cable and with one anchor point showing a variant in construction.

FIG. 4 is a schematic side view depiction of the essential frame, tongue shaft and wheel support arms of the invention with simple cable routing according to one variant wherein the shaft and arms rotate in opposite directions.

FIG. 5 is a schematic side view depiction of the essential frame, tongue shaft and wheel support arms of the invention with simple cable routing according to another variant wherein the shaft and arms rotate in the same directions.

FIG. 6 is a schematic side view depiction as in FIG. 4 with one set of leveraging pulley present the ends of the wheel support arm's.

FIG. 6A is a detail of an alternate version of multiple leveraging pulleys as an alternative to the arrangement of FIG. 6.

FIG. 7 is a schematic side view showing the view of FIG. 4 with cabling omitted after the trailer has been converted from loading mode to traveling mode, with the wheel support arm and tongue shaft precisely aligned with the frame.

### BRIEF DESCRIPTION OF THE PREFERED EMBODIMENT

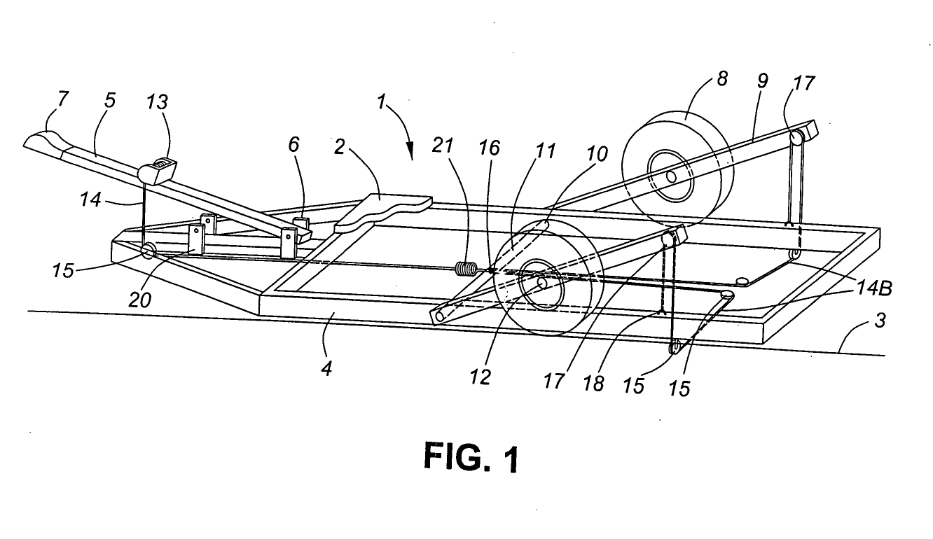

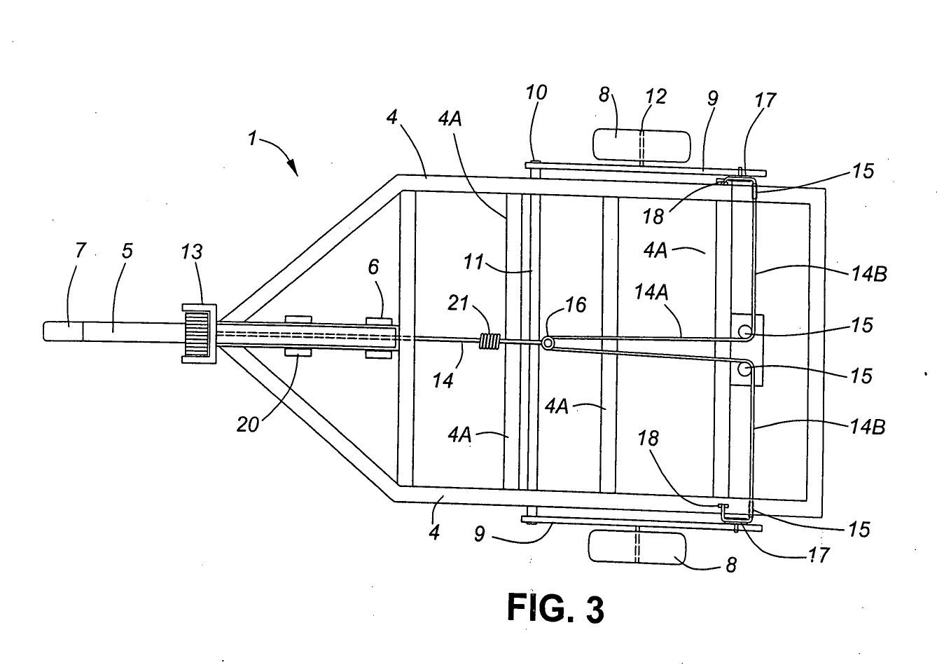

As depicted in FIGS. 1, 2 and 3 a vehicle trailer 1 is provided with a platform or bed 2 (shown only partially) for supporting cargo. This bed 2 may be lowered to the road surface 3 beneath the trailer 1 for loading, and then may be elevated for transport. This is achieved by providing a cargo bed 2 supported by a frame 4 that is fitted at its forward end with a centrally aligned hinged tongue shaft 5. Multiple transverse frame members 4A, shown only in FIG. 3, may be present in order to stiffen the frame 4.

The rearward end of the tongue shaft 5 is coupled to the frame through a first hinge pin passing through a support 6 Mt. of on the frame 4. The forward end of the tongue shaft 5 is provided with hitch 7 means for coupling to a vehicle. This hitch 7, shown as, according to one variant, cupped for fitting on a ball, is capable of allowing the tongue shaft 5 to be angled both laterally, and in a vertical plane.

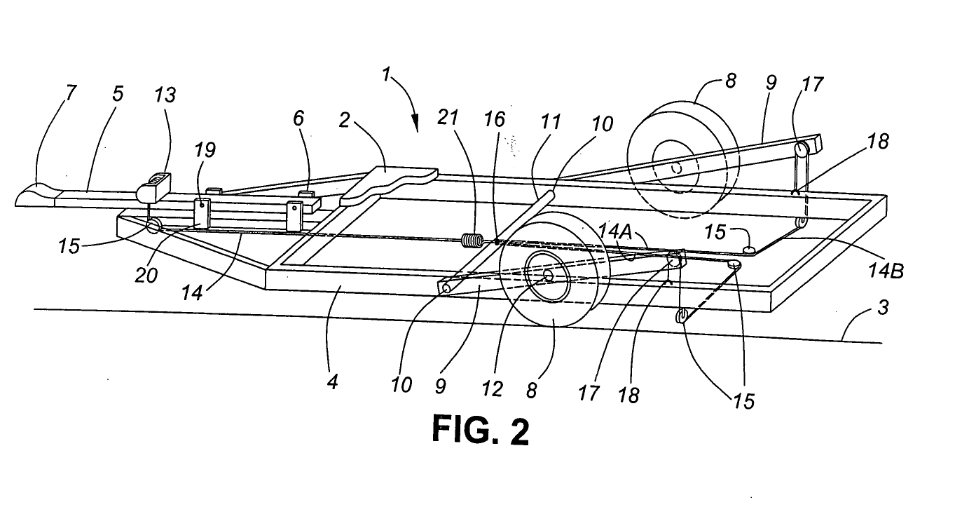

The frame 4, shown only in terms of its principal outer, defining members in FIGS. 1 and 2, may be generally planar or may depart from a planar configuration. For purposes of description, the frame 4 will be described as if it were planar and in the case of a nonplanar frame, “frame” herein refers to the hypothetical planar frame which is best fitted to the actual frame in order to achieve the purposes of the invention. Coupling to the frame 4 may be effected directly, or through extensions from the frame 4. Extensions from the frame 4 for this purpose are considered to be part of the “frame”.

Wheels 8 are fitted to the frame by wheel support arms 9 that are connected at one end to the frame 4 through a second hinged joint 10. Two wheel arm hinge joints 10 couple the respective wheel support arms 9 to the frame 4. This may be effected through separate hinge pins on each side of the trailer 1, aligned along a common wheel arm hinge pin axis that extends transversely across the trailer's width. Or, as shown, the respective wheel support arms 9 may share a common hinge shaft 11 to which they are fastened, causing the arms 9 to rotate in unison. This common hinge shaft 11 is journalled into the frame 4 on the respective sides of the trailer 1.

Wheel support arms 9 are provided on both sides of the frame 4 and each wheel support arm 9 may carry one or more wheels 8. The wheels 8 are connected to the wheel support arms 9 through wheel axles 12. The wheels 8 may be connected to the wheel support arms 9 either directly or through spring/suspension means (not shown).

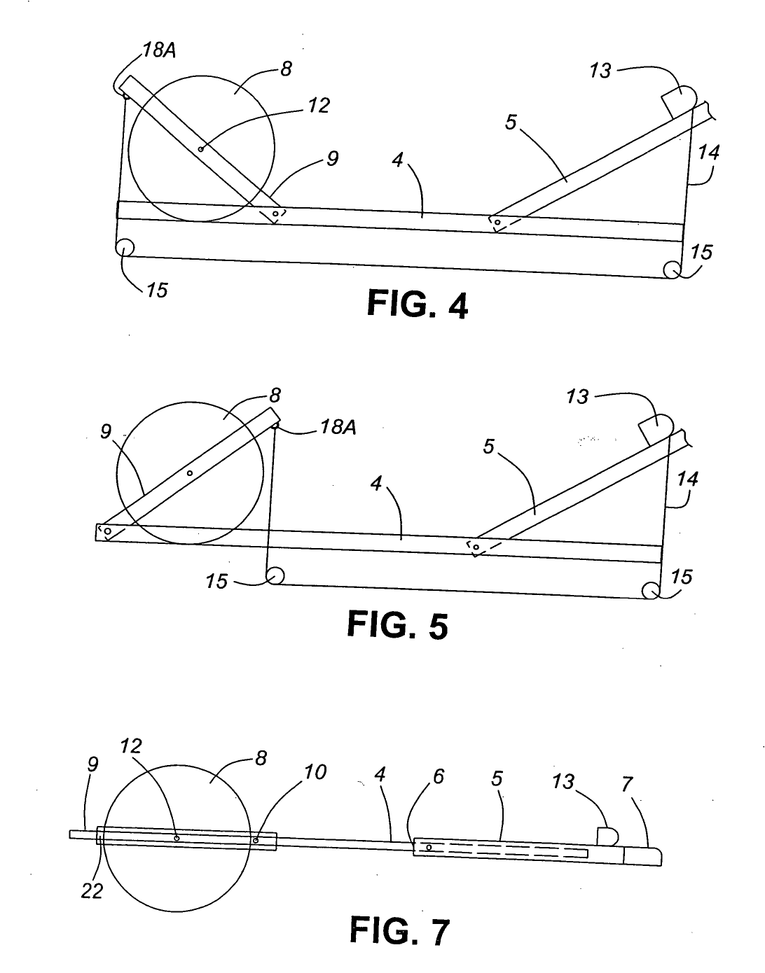

The wheel support arms 9 may be connected at an end that causes such arms 9, with the elevation and lowering of the trailer bed 2, to rotate in the opposite direction to the rotation of the tongue shaft 5. This configuration is showing schematically in FIG. 4. Alternately, the wheel support arms 9 may be connected to the frame 4 or frame extensions at an end that permits the wheel support arms 9 to rotate in parallel with the tongue shaft 5 as it rotates. This configuration is showing schematically in FIG. 5. In advantage of the FIG. 4 for configuration is that the wheels are trailing the wheel support arm hinges 10. In the FIG. 5 configuration, in traveling mode, it is desirable that the wheel support arms 9 be fastened to the frame at their forward ends.

To cause the trailer 1 to convert from the loading configuration to the traveling configuration, means is provided to force the rotation of both the tongue shaft 5 and wheel support arms 9. Various means may be provided to force such rotation, including air cylinders, hydraulic cylinders. One example (not shown) is by use of threaded shafts extending between the frame and, respectively, the tongue shaft and each of the wheel support arms. Such threaded shafts would be threaded in such directions as to force the desired rotations of the tongue shaft and wheel support arms in response to rotation of the threaded shafts.

A preferred means for effecting rotation of the tongue shaft 5 and wheel support arms 9 employs a cable linkage system employing cable 14 connected at one end to the tongue shaft 5 and at the other end to the respective wheel support arms 9. The cable is routed through direction-change pulleys 15, akin to fairleads, or the equivalent means connected to the frame 4. These direction-change pulleys 15 can, optionally, be swivel-mounted to minimize stress on the cable 14.

Cable take-up means is engaged to take-up and shorten the span of the cable 14. The effect of shortening the cable 14 causes the tongue shaft 5 and wheel support arms 9 to be respectively drawn from the configurations of FIGS. 4 and 5 towards alignment with the frame 4 and e s in FIG. 7, as a preferred traveling arrangement. The shortening of the cable carries the cargo bed 2 to its elevated position as in FIGS. 2 or 7. Letting out the cable 14 allows the cargo bed 2 to descend, as in any one of FIGS. 1, 4 or 5.

The cable take-up system may be based upon winch means 13 preferably mounted in association with the tongue shaft 5. The winch may either be powered or manual.

A powered winch 13 is showing mounted on the tongue shaft 5 as a convenient location. The winch 13 could, alternately, be mounted to the frame 4 below as another convenient location. Extending from the winch is a cable 14 which is routed down the central axis of the trailer 1, changing directions at direction-change pulleys 15 as particularly shown in FIG. 3.

The winch 13 may provide for the take-up of dual cables that extend the entire length of the trailer 1 from the winch 13 to each of the wheel support arms 9. Alternately, as depicted, the winch 13 may take-up a single cable 14A which, after being partially routed along the frame 4 as a single cable, bifurcates at a coupling 16 into two sub-cables 14B that proceed to the respective wheel support arms 9. Conveniently, the two sub-cable portions 14B can be part of a single sub-cable that connects to the main cable portion 14A through a hook means 16 which serves to provide an adjustable, approximately bisecting, pulling point, allowing the lengths of the two sub-cable portions 14B to be adjusted to fit their required travel.

Preferably, a central frame-strengthening channel member (not shown) extends down the central axis of the trailer 2 at least partially enclosing and protecting the cable 14. To provide further strength for the frame 4, transverse channel-like member 4A or the equivalent, such as box tubing, may be provided. Such a transverse member 4A may be positioned close to the run of the cable portions 14B as the cable 14 is routed from the central axis to the respective wheel support arms 9. This cable-proximate transverse member 4A may be connected to the underside of the peripheral tubing of the frame 4 at its outer periphery, stiffening the frame and distributing the lifting force of the cable, as next described.

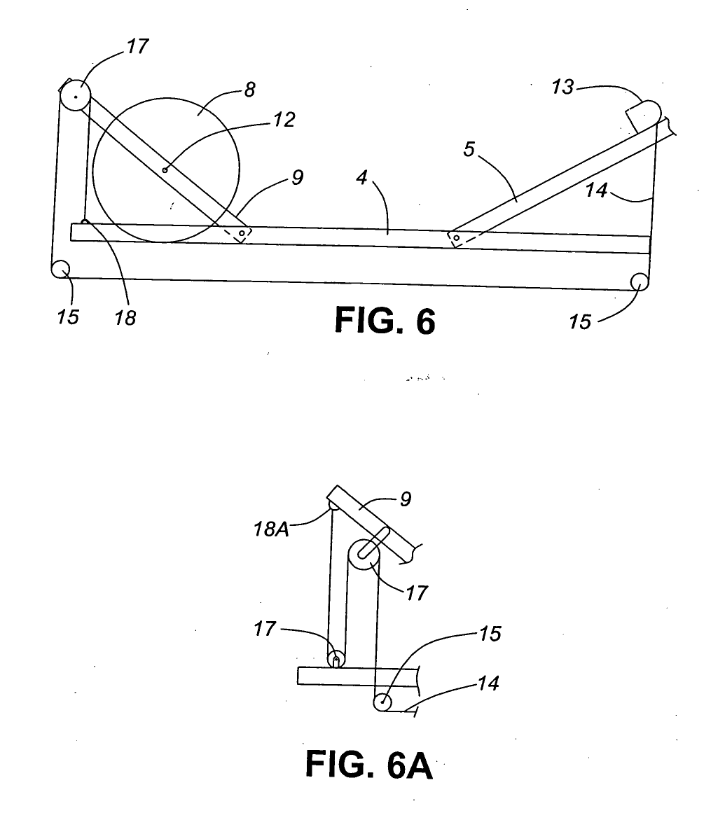

Shortening the cable causes the cargo bed 2 to become elevated. The cabling 14 may be routed to achieve this result directly, employing a minimum number of direction-change pulleys 15 as shown in FIGS. 4 and 5; or may be routed through multiple, additional, leveraging pulleys to achieve a leveraging effect, as shown in FIGS. 6, 6A. Rounding the last direction-change pulleys 15, the cable portions 14B as shown in FIGS. 6 and 6A can extend up to a leveraging pulley 17 on each wheel support arm 9 and, in FIG. 6, back down to anchor points 18 on the frame 4. Or transverse number 4A. This provides a 2:1 leveraging advantage for the cable in applying force to the outer ends of the wheel support arms 9.

In FIG. 6A, the cable 14B rounds a second leveraging pulley 17 and is anchored to the wheel support arm at anchor point 18A. This provides a 4:1 leveraging advantage for the cable. Similar leveraging pulleys may be applied (not shown) at the tongue support shaft 5 end of the cable 14.

If desired, additional leveraging pulleys (not shown) may be provided to produce, for example, even greater leveraging advantages of 8:1, etc. Such leveraging pulleys 17 may be present either at the tongue shaft 5 of the trailer 1 or in association with the wheel support arms 9.

As a detail not shown in FIGS. 1 end 2, the wheel support arms 9 may be “cranked” at one or more of their ends so as to displace the pulling force of the cable and/or common hinge shaft 11 into alignment with the center of the wheels 8. This more readily accommodates the torque generated by the wheel axle 12 at its connection to the wheel support arm 9.

The operation of the trailer 1 will now be described. For simplification of the explanation, the trailer 1 will be described in the configuration as if the hitch portion 7 of the tongue shaft 5 were connected to a towing vehicle at a height above the ground that is equal to the height of the frame 4 of the trailer 1 when the platform 2 of the trailer 1 is in its elevated condition. A typical height might be 15 inches. Displacement of the cargo bed 2 of the trailer 1 may, of course, be effected with the hitch 7 at an alternate height, or even in contact with the ground 3 if there is no interference from portions of the frame 4.

The frame 4 is lowered to rest against or nearly against the road surface 3 as a loading configuration by rotating both the tongue shaft 5 and the wheel support arms 9 upwardly, away from alignment with the frame 4. This is achieved by letting-out cable 14. The frame 4 is raised upwardly from the road surface 3 into a traveling configuration by rotating the tongue shaft 5 and the wheel support arms 9 downwardly, towards alignment with the frame 4. This is achieved by taking-in cable 14. Preferably, when in traveling configuration, the wheel support arms 9 and tongue shaft 5 are nearly or fully aligned with the frame 4. Such a full alignment is not essential.

Extensions from the frame 4 together with locking pins may engage the arms 9 and shaft 5 to the frame 4 so that during travel these components are fixed together; or the trailer 1 may travel with the weight of the load carried wholly or in part by the cable 14. Thus locking pins may be inserted respectively through the tongue shaft 5 and wheel support arms 9 to engage with member portions of the frame 4. For example, one or more such pins 19 may be inserted to anchor the tongue shaft 5 to an extension 20 fixed to the frame 4. And a locking pin may be inserted at point 22, as shown in FIG. 7, through the wheel support arm 9 into the frame 4.

As depicted in FIG. 2, the load of the cargo bed 2 and its cargo is carried by the cable 14 while traveling. By selection of cable 14 which is both sufficiently strong and resilient, a suspension or cushioning effect can then be achieved for the cargo platform 2. This suspension effect can be further improved by inclusion of spring means 21 in the tension-bearing cable links extending between the tongue shaft 5 and the wheel support arms 9 in conjunction with the cabling 14. As shown in FIGS. 1, 2 and 3, this spring 21 can be fitted at the link/hook 16 where the cable 14 transitions into the two sub-cable portions 14B. This spring means 21 then serves to absorb shock when the cable 14 is carrying a load. For security purposes, when reliance is placed upon the cable 14 to provide a suspension function, loosely attached chain links (not shown) may be engaged between the free ends of the wheel support arms 9 and the frame 2, the tongue shaft 5 being locked in place by pin 19, to take the load if the cable 14 gives way.

Placing of the cargo bed 2 in an inclined configuration may be achieved by supporting either one end or the other of the trailer bed while letting-out the cable. This can be achieved through use of an external support such as a jackstand, by installation of locking pins as described above at only one end of the trailer 1, or by attachment of the safety chain links to the wheel support arms 9 as referenced above.

Thus, while a vehicle such as a snowmobile (which may not have a reverse drive), may for example be loaded onto the cargo bed 2 by lowering only the rearward end of the frame 4 to the ground, for unloading, the cargo bed 2 may be simply tipped forwardly until the forward edge of the platform contacts the ground. Then the snowmobile may simply drive off, turning aside slightly to bypass the tongue shaft 5.

Although the cargo platform 2 can be lowered until it rests adjacent to the ground, such platform 2 will not necessarily remain in a horizontal orientation during the transition to traveling mode. However, coupled with the judicious selection of distances:
from the tongue shaft hinge support 6 to the cable connection points on the tongue shaft 5,
from the cable connection points on the tongue shaft 5 to the hitching point 7,
from the wheel support arms hinges 10 to the wheel axles 12,
from the wheel axles 12 to the cable connection points or leveraging pulley 17 location on the wheel support arms 9, combined with:
the effective location of the combined weight of vehicle load and trailer mass to be elevated, and
the number and location of leveraging pulleys 17 employed, the cargo bed platform 2, with the assistance of
   minimal corrective force to overcome imbalances and friction etc., can largely be maintained in a relatively horizontal orientation while such platform 2 is being elevated. This simplifies the anchoring of the load to the cargo bed 2 during loading, although full anchoring of such load for purposes of travel may still be required.

### CONCLUSION

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

I claim:

1. A vehicle trailer comprising:
a) cargo bed for supporting cargo for being lowered to the road surface beneath the trailer for loading, and for being elevated for transport;
b) a frame with frame member portions supporting the cargo bed;
c) a tongue shaft connected to the frame for rotation at its rearward end through a first hinged joint, the forward end of the tongue shaft being provided with hitch means for coupling to a vehicle;
d) a pair of wheel support arms that are connected at one end of each of the respective arms to the frame through respective second hinged joints to permit the wheel support arms to rotate in conjunction with the rotation of the tongue shaft, the other ends of said arms being free of interconnection to each other by any interconnection that passes above the level of said cargo bed;
e) at least two wheels fitted respectively through wheel axles to the wheel support arms, and
f) means to cause rotation of both the tongue shaft and wheel support arms to permit the frame and cargo bed to be lowered or raised with respect to the wheel axles.

2. A vehicle trailer as in claim 1 wherein the frame is lowered to a loading configuration by rotating both the tongue shaft and the wheel support arms upwardly, away from alignment with the frame.

3. A vehicle trailer as in claim 1 wherein the frame is raised upwardly into a traveling configuration by rotating both the tongue shaft and the wheel support arms downwardly, towards alignment with the frame.

4. A vehicle trailer as claim 3 wherein, said rotation of both the tongue shaft and wheel support arms occurs simultaneously.

5. A vehicle trailer as in claim 1 wherein the wheel support arms, with the elevation and lowering of the frame, rotate in the same direction as the tongue shaft as the tongue shaft rotates.

6. A vehicle trailer as in claim 1 wherein the wheel support arms, with the elevation and lowering of the frame, rotate in the opposite direction to the rotation of the tongue shaft.

7. A vehicle trailer as in claim 1 comprising locking pins means for coupling the tongue shaft into engagement with member portions of the frame.

8. A vehicle trailer as in claim 1 comprising coupling means to secure the wheel support arms to the frame while the cargo platform is elevated in a traveling configuration.

9. A vehicle trailer as in claim 1 comprising:
a) a cable linkage system employing cable connected at one end to the tongue shaft and at the other end to each of the wheel arm support shafts, said cable being routed through pulley means connected to the frame;
b) take-up means carried by the trailer to take-up the cable,
whereby the taking-up and shortening of the cable causes the tongue shaft and wheel support arms to be respectively drawn towards alignment with the frame concurrently with elevation of the frame and cargo bed to establish a traveling configuration.

10. A vehicle trailer as in claim 9 comprising a winch mounted on the trailer to serve as take-up means for the cable.

11. A vehicle trailer as in claim 10 wherein said winch is mounted in association with the tongue shaft.

12. A vehicle trailer as in claim 10 wherein said winch is mounted in association with the frame.

13. A vehicle trailer as in claim 10 comprising one or more leveraging pulleys wherein said cable is routed through said one or more leveraging pulleys to achieve a leveraging effect.

14. A vehicle trailer as in claim 10 comprising spring means connected in association with the cable to absorb shock when the cable is carrying a load.

15. A method of loading cargo onto a vehicle trailer from a road surface, the vehicle trailer comprising:
a) a cargo bed for supporting cargo that may be lowered to the road surface beneath the trailer for loading, and then may be elevated for transport;
b) a frame supporting the cargo bed;
c) a tongue shaft connected to the frame for rotation at its rearward end through a hinged joint, the forward end of the tongue shaft being provided with hitch means for coupling to a vehicle;
d) a pair of wheel support arms that are connected at one end of each of the respective arms to the frame through respective hinged joints to permit the wheel support arms to rotate in conjunction with the rotation of the tongue shaft, the other ends of said arms being free of interconnection to each other by any interconnection that passes above the level of said cargo bed;
e) at least two wheels fitted through wheel axles to the wheel support arms, and
f) means to cause rotation of both the tongue shaft and wheel support arms to permit the frame and cargo bed to be lowered or raised with respect to the wheel axles,
the method comprising:
i) causing rotation of either the tongue shaft or wheel support arms to occur preferentially to the other, permitting either the forward end or rearward end of the cargo bed to contact the road surface with the other end of the cargo bed remaining elevated, and
ii) advancing a load either onto or off of the cargo platform over the end of the cargo bed which is in contact with the road surface.
